(19) United States
(12) Patent Application Publication
(10) Pub. No.: US 2016/0123855 A1
(43) Pub. Date: May 5, 2016

(54) ELECTRICALLY CONDUCTIVE SAMPLE BLOCKS FOR SCANNING ELECTRON MICROSCOPY

(71) Applicants: Rainer FRIEDRICH, Lörrach (DE); Christel GENOUD, Basel (CH); Adrian WANNER, Buchrain (CH)

(72) Inventors: Rainer FRIEDRICH, Lörrach (DE); Christel GENOUD, Basel (CH); Adrian WANNER, Buchrain (CH)

(73) Assignee: Friedrich Miescher Institute for Biomedical Research, Basel (CH)

(21) Appl. No.: 14/897,514

(22) PCT Filed: Jun. 12, 2014
(86) PCT No.: PCT/IB2014/062157

§ 371 Date: Dec. 10, 2015

(30) Foreign Application Priority Data
Jun. 14, 2013 (EP) 13172118.5

(51) Int. Cl. G01N 1/36; B22F 1/02; B22F 1/00

(52) U.S. Cl. CPC G01N 1/36; B22F 1/0044; B22F 1/025; G01N 2001/364; B22F 2301/255; B22F 2301/15; B22F 2304/05; B82Y 15/00

(57) ABSTRACT

The present invention provides a method for preparing a sample for microscopy, said method comprising the steps of contacting said sample with a first polymerizable resin under conditions and for a time sufficient for penetration of said first polymerizable resin into the sample, removing excessive first polymerizable resin from the surface of the sample, contacting the so-prepared sample containing said first polymerizable resin with a second polymerizable resin preparation, said second polymerizable resin preparation comprising a high concentration of electrically conductive particles, and subjecting the so-prepared sample to the curing temperature of the polymerizable resins, wherein the curing temperature of said second polymerizable resin preparation is substantially the same as the curing temperature of the first polymerizable resin.

### BACKGROUND OF THE INVENTION

Serial block face scanning electron microscopy (SBEM) is a method that takes images from the face of a sample block and removes ultrathin sections from the block face between successive images. Images from the block face are acquired with a scanning electron microscope (SEM) and sections are cut with an automated ultramicrotome inside the vacuum chamber. The method can be used to acquire three-dimensional (3-D) stacks of images from biological samples at high resolution (<30 nm) throughout large volumes (>100×100×100 μm³). A closely related method (FIB-SBEM) mills the surface of the tissue block using a focused ion beam instead of cutting with an ultramicrotome. This method can achieve thinner sectioning but is restricted to smaller volume dimensions. In another alternative method to obtain 3-D images, stacks of electron microscopic images may be obtained by collecting serial sections on a support, imaging each section in a scanning or transmission electron microscope, and combining the images into a stack. This approach requires more demanding image registration procedures. Moreover, it usually requires a large amount of manual labor unless automated procedures are used for labor-intensive steps in the workflow. In SBEM, the electrons deposited on the sample during image acquisition charge the surface of the sample. This charging drastically limits SBEM to a narrow range of imaging parameters. In order to remove charges from the sample block, images often have to be acquired under conditions with residual water vapor in the vacuum chamber. These conditions reduce image quality and preclude the use of many microscope models. The charging causes local distortions in the electric field on the surface of the sample. As a consequence, the image gets distorted/warped during the acquisition, which compromises the alignment of subsequent sections. This effect is even more pronounced if the sample is scanned with low voltages (<3kV). Moreover, the charging effect precludes the use of detection methods that can enhance image contrast and acquisition speed in SEM applications, e.g. the detection of secondary electrons. Furthermore, charging complicates ultrathin sectioning because it changes the properties of the embedding medium by a yet unknown mechanism. As a consequence, improvements of image quality by increasing the electron dose or voltage require thicker sectioning. This effectively reduces the resolution of the method in the third dimension (z).

Charging of the sample could be reduced by embedding the sample in a conductive medium. However, the mechanical and chemical properties of the embedding medium are critical for the preservation and stability of the sample. So far, no conductive medium with suitable properties has been found. Typical embedding media used in SBEM are specific epoxy resins. The mechanical properties of these resins are suitable for SBEM but the resins are non-conductive.

There is hence a need in the art for an embedding medium that is electrically conductive but preserves the chemical and mechanical properties of conventional embedding media such as epoxy resins.

### SUMMARY OF THE INVENTION

The present inventors have now surprisingly found a medium and developed a sample preparation procedure that provides electrically conductive sample blocks. These blocks substantially improve the conditions for imaging of biological samples in serial block face scanning electron microscopy (SBEM). Because the electrically conductive sample blocks efficiently remove charging from the surface of the block, the local electric field on the surface of the block is much more stable and distortions of the acquired images are significantly reduced. Hence, sample blocks embedded in this medium allow for substantially thinner sectioning while preserving high image quality. Using the method and reagents of the invention, it is possible to achieve improved imaging and sectioning effects under conditions of “high vacuum”, i.e. with very low amounts of residual water in the vacuum chamber, as normally used in scanning electron microscopy. As a consequence, it is possible to use a wider variety of image acquisition modes as compared to the “classical” methods known in the art.

The present invention hence provides a method for preparing a sample for microscopy, said method comprising the steps of contacting said sample with a first polymerizable resin under conditions and for a time sufficient for penetration of said first polymerizable resin into the sample, removing excessive first polymerizable resin from the surface of the sample, contacting the so-prepared sample containing said first polymerizable resin with a second polymerizable resin preparation, said second polymerizable resin preparation comprising a high concentration of conductive particles, and subjecting the so-prepared sample to the curing temperature of the polymerizable resins, wherein the curing temperature of said second polymerizable resin preparation is substantially the same as the curing temperature of the first polymerizable resin.

In some embodiments of the invention, the polymerizable resin is a thermosetting polymer, for example an epoxy resin.

In some embodiments, the first polymerizable resin is a water-soluble epoxy resin. The electrically conductive particles used in the invention, which particles can be nanoparticles, can be any electrically conductive particle, or flake. For instance, they can be gold particles, silver particles, nickel particle, graphite particles, and/or silver-coated particles.

In the frame of the present invention, the concentration of the electrically conductive particles in the second polymerizable resin preparation is typically between 30 and 90 WT %.

### BRIEF DESCRIPTION OF THE DRAWINGS

FIG. 1: Comparative images. Sample A (prepared according to the present invention) and sample B (prepared conventionally, i.e. without conductive resin) imaged in the exact same microscope conditions in the same microscope: 5 microseconds per pixel, 13 nm per pixel, 2 kV, spot size 3, 0.08 Torr water.

FIG. 2: Pixel profiles. The profile corresponds to grey values of pixels located along the bold line in the image. The dynamic range in for sample A is by a factor of 2 larger than for sample B.

FIG. 3: Comparison of local image distortions. Sample A (prepared according to the present invention) and sample B (prepared conventionally, i.e. without conductive resin) imaged in the exact same microscope conditions in the same microscope: 5 microseconds per pixel, 10 nm per pixel, 2.5 kV, 48 picoampere beam current, in high vacuum mode. For both, sample A and sample B, overlayed images of two subsequent acquisitions of the same region of interest (ROI) are shown. The original image of the ROI is shown in red. The overlayed green image was acquired after scanning the same ROI 4 times with the same imaging conditions. In sample B the repeated scanning of the ROI charged the surface which in turn caused distortions in some regions of the image (bottom). In addition, the field of view drifted by 590 nm on the Y-axis and by 290 nm on the X-axis. In contrast, in sample A there is almost no distortion or drift observable. Scale bars: 2.5 μm (top) and 1 μm (bottom).

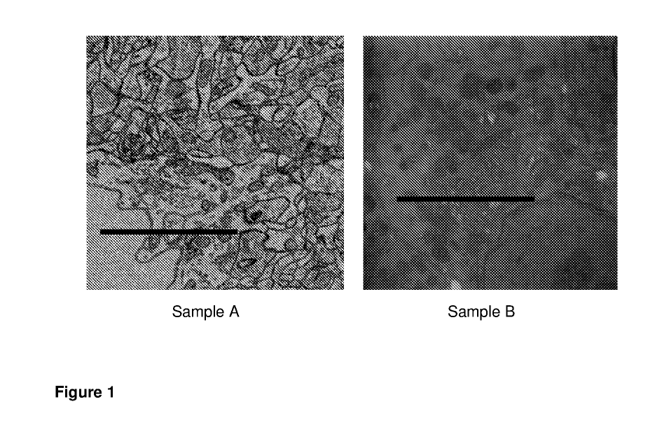

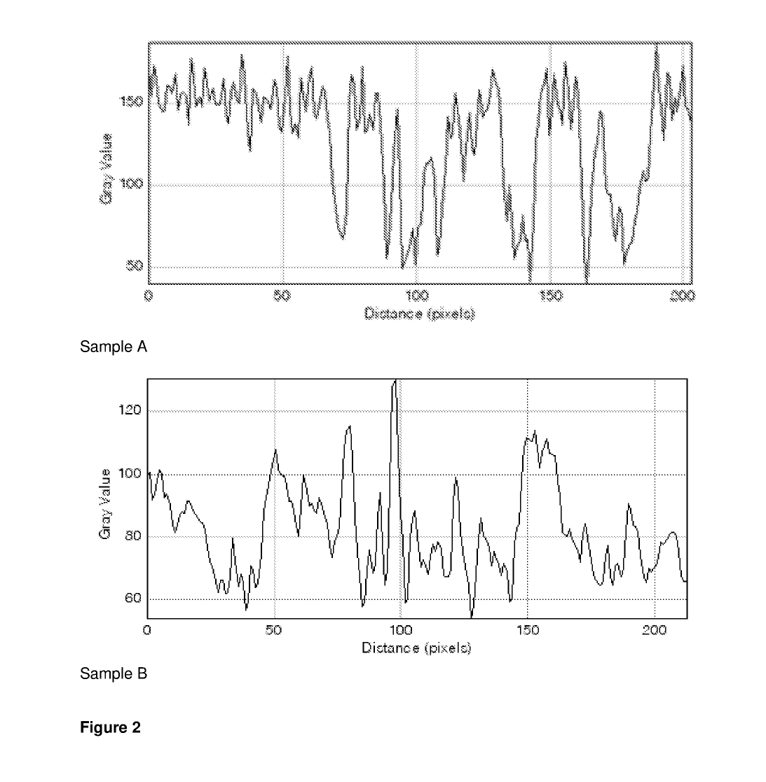

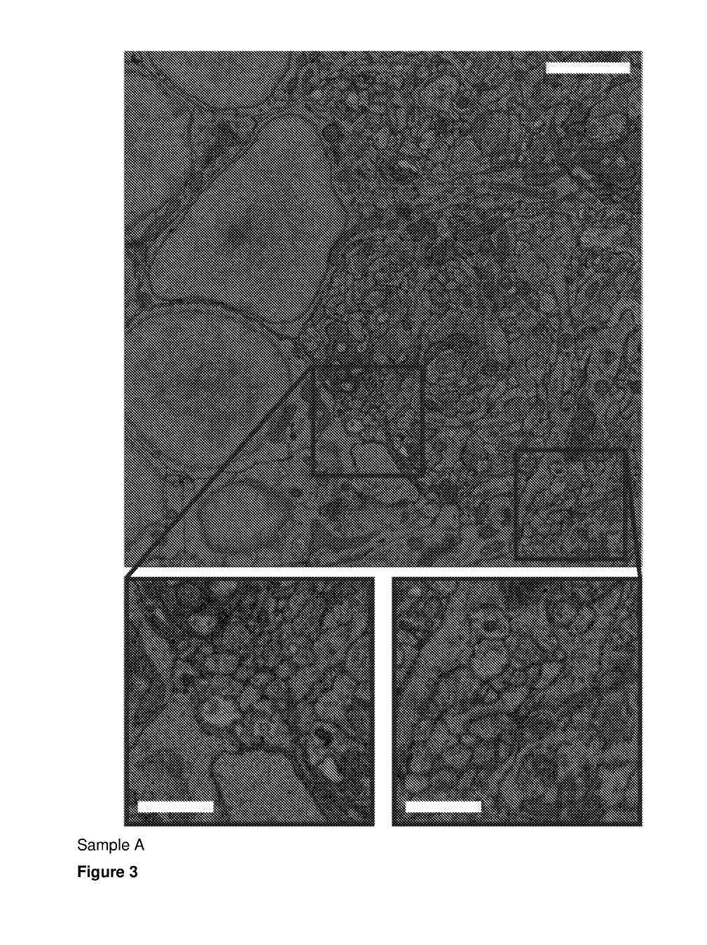

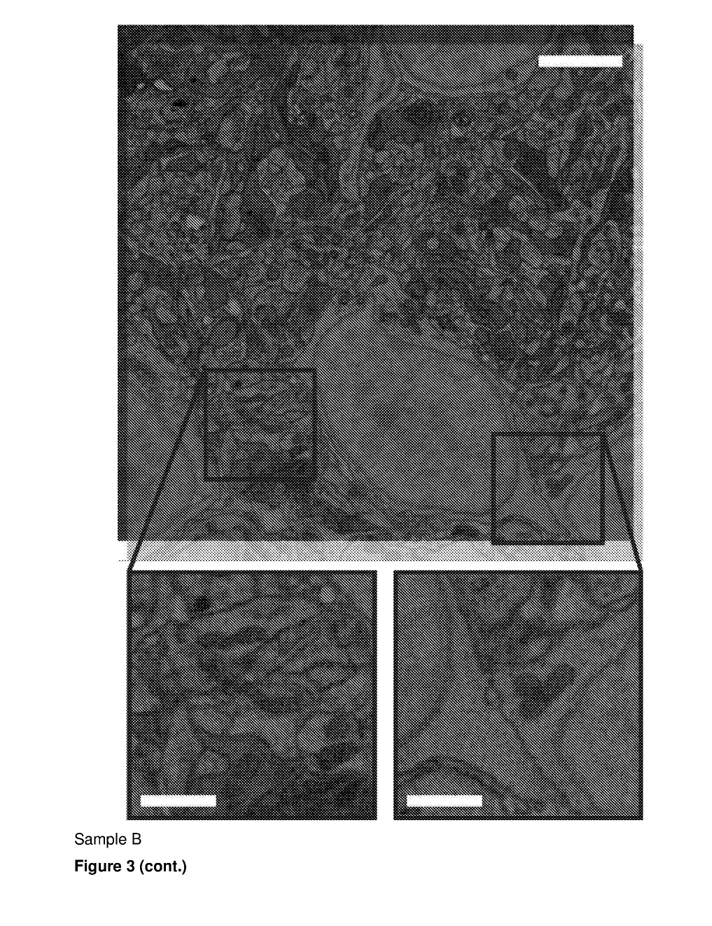

### DETAILED DESCRIPTION OF THE INVENTION

The present inventors have now surprisingly found a medium and developed a sample preparation procedure that provides electrically conductive sample blocks. These blocks substantially improve the conditions for imaging of biological samples in serial block face scanning electron microscopy (SBEM). Because the electrically conductive sample blocks efficiently remove charging from the surface of the block, the local electric field on the surface of the block is much more stable and distortions of the acquired images are significantly reduced. Hence, sample blocks embedded in this medium allow for substantially thinner sectioning while preserving high image quality. Using the method and reagents of the invention, it is possible to achieve improved imaging and sectioning effects under conditions of “high vacuum”, i.e. with very low amounts of residual water in the vacuum chamber, as normally used in scanning electron microscopy. As a consequence, it is possible to use a wider variety of image acquisition modes as compared to the “classical” methods known in the art.

The present invention hence provides a method for preparing a sample for microscopy, said method comprising the steps of contacting said sample with a first polymerizable resin under conditions and for a time sufficient for penetration of said first polymerizable resin into the sample, removing excessive first polymerizable resin from the surface of the sample, contacting the so-prepared sample containing said first polymerizable resin with a second polymerizable resin preparation, said second polymerizable resin preparation comprising a high concentration of electrically conductive particles, and subjecting the so-prepared sample to the curing temperature of the polymerizable resins, wherein the curing temperature of said second polymerizable resin preparation is substantially the same as the curing temperature of the first polymerizable resin. In some embodiments of the invention, the polymerizable resin is a thermosetting polymer, for example an epoxy resin.

In some embodiments, the first polymerizable resin is a water-soluble epoxy resin. The electrically conductive particles used in the invention, which particles can be nanoparticles, can be any electrically conductive particle, or flake. For instance, they can be gold particles, silver particles, nickel particle, graphite particles, and/or silver-coated particles.

In the frame of the present invention, the concentration of the electrically conductive particles in the second polymerizable resin preparation is typically between 30 and 90 WT %.

As used herein, an “image” is to be interpreted as an image displayed on a display unit as well as a representation thereof in e.g. a computer memory.

A problem when observing certain materials, such as polymers and biological tissues, is that the contrast of the specimen may be too poor to easily differentiate features of the specimen. As known to the person skilled in the art, in order to improve contrast, specimens may be stained to preferentially highlight some parts of the specimen over others. For stains to be effective, they have to preferentially bind to some parts of the specimen, thereby differentiating between different parts of the specimen.

In electron microscopy, heavy metal salts may be used as a staining agent. Such heavy metal salts are commonly derived from gold, uranium, ruthenium, osmium, or tungsten. Heavy ions are used since they will readily interact with the electron beam and produce phase contrast, absorption contrast and/or produce backscattered electrons as well as secondary electrons.

Some of these heavy metal salts adhere to specific substances of the specimen. An example of that is OsO4 (osmium tetroxide), which form a specific chemical reaction with the double bonds of unsaturated fatty acids found e.g. in lipid membranes of cells and organelles.

Other staining agents that may be used are e.g. compounds of a heavy metal with e.g. an appropriate biologically active group, such as an antibody. Such staining agents are also known as labels. An example is colloidal gold particles absorbed to antibodies. Other examples of this group of staining agents are the Nanogold® particles, produced by Nanoprobes Inc., USA, which may be used to label any molecule with a suitable reactive group such as oligonucleotides, lipids, peptides, proteins, and enzyme inhibitors. To stain a specimen the specimen is exposed to the staining agent. The exposure can take the form of temporarily immersing the specimen in a liquid, such as a 1% solution of OsO4. Further steps in the staining process may include washing the specimen with water, alcohol, etc. Such staining processes are e.g. described by “Dermatan sulphate-rich proteoglycan associates with rat-tendon collagen at the d band in the gap region”, John E. Scott and Constance R. Orford, Biochem. J. (1981) 197, pages 213-216 as well as in Tapia, J. C., et al. (2012). “High-contrast en bloc staining of neuronal tissue for field emission scanning electron microscopy.” Nat Protoc 7(2): 193-206(Tapia, Kasthuri et al. 2012). The exposure can also take the form of exposing the specimen to a gas or vapour of the staining agent. This is e.g. described in “Observation on backscattered electron image (BEI) of a scanning electron microscope (SEM) in semi-thin sections prepared for light microscopy”, Y. Nagata et al., Tokai J. Exp. Clin. Med., 1983 May 8(2), pages 167-174. For a good contrast the specimen must be sufficiently stained. There is however an optimum in the staining dose: too much staining results in a decrease of the contrast as too much of the specimen becomes stained, whereby the (stained) structures of interest do not stand out to the background anymore. An adequate dose of staining must thus be found.

Although any standard staining method is suitable for the performance of the present invention, the protocol of Deerinck et al (NCMIR) seems the most efficient one as it makes the sample itself significantly more conductive.

Biological samples to be prepared for observation by electron microscopy are usually embedded so that can be sectioned ready for viewing. To do this the tissue can be passed through a ‘transition solvent’ such as ethanol, acetone or Propylene oxide (epoxypropane) and then infiltrated with an epoxy resin such as Araldite, Epon, Spurr, Quetol, or Durcupan. Samples may also be embedded directly in water-miscible acrylic resin. Polymerization (hardening) of the resin allows the thin sectioned (ultrathin sections) of the sample.

“Curing” is a term in polymer chemistry and process engineering that refers to the toughening or hardening of a polymer material by cross-linking of polymer chains, brought about by chemical additives, ultraviolet radiation, electron beam or heat. In rubber, the curing process is also called vulcanization.

Despite the wide variety of thermoset resin formulations (epoxy, vinylester, polyester, etc.), their cure behavior is qualitatively identical. The resin viscosity drops initially upon the application of heat, passes through a region of maximum flow and begins to increase as the chemical reactions increase the average length and the degree of cross-linking between the constituent oligomers. This process continues until a continuous 3-dimensional network of oligomer chains is created—this stage is termed gelation. After gelation the mobility in the sample is very limited, the micro-structure of the resin and the composite material is fixed.

A cured thermosetting polymer is called a “thermoset”.

A thermosetting polymer is a prepolymer in a soft solid or viscous state that changes irreversibly into an infusible, insoluble polymer network by curing. Curing can be induced by the action of heat or suitable radiation, or both.

“Epoxy” is both the basic component and the cured end product of epoxy resins, as well as a colloquial name for the epoxide functional group.

“Epoxy resins”, also known as polyepoxides are a class of reactive prepolymers and polymers which contain epoxide groups. Epoxy resins may be reacted (cross-linked) either with themselves through catalytic homopolymerisation, or with a wide range of co-reactants including polyfunctional amines, acids (and acid anhydrides), phenols, alcohols, and thiols. These co-reactants are often referred to as hardeners or curatives, and the cross-linking reaction is commonly referred to as curing. Reaction of polyepoxides with themselves or with polyfunctional hardeners forms a thermosetting polymer, often with high mechanical properties, temperature and chemical resistance. Epoxy has a wide range of applications, including metal coatings, use in electronics/electrical components, high tension electrical insulators, fiber-reinforced plastic materials, and structural adhesives.

In general, uncured epoxy resins have only poor mechanical, chemical and heat resistance properties. However, good properties are obtained by reacting the linear epoxy resin with suitable curatives to form three-dimensional cross-linked thermoset structures. This process is commonly referred to as curing. Curing of epoxy resins is an exothermic reaction.

Curing may be achieved by reacting an epoxy with itself (homopolymerisation) or by forming a copolymer with polyfunctional curatives or hardeners. In principle, any molecule containing a reactive hydrogen may react with the epoxide groups of the epoxy resin. Common classes of hardeners for epoxy resins include amines, acids, acid anhydrides, phenols, alcohols and thiols. Relative reactivity (lowest first) is approximately in the order: phenol<anhydride<aromatic amine<cycloaliphatic amine<aliphatic amine<thiol.

Whilst some epoxy resin/hardener combinations will cure at ambient temperature, many require heat, with temperatures between 50 and 70° C. up to 150° C. being common, and up to 200° C. for some specialist systems but strictly restricted to material science as biological samples are destroyed at high temperatures. Insufficient heat during cure as well as presence of water/air in the resin will result in a network with incomplete polymerization, and thus reduced mechanical, chemical and heat resistance. Cure temperature should typically attain the glass transition temperature (Tg) of the fully cured network in order to achieve maximum properties. Temperature is sometimes increased in a step-wise fashion to control the rate of curing and prevent excessive heat build-up from the exothermic reaction.

Hardeners which show only low or limited reactivity at ambient temperature, but which react with epoxy resins at elevated temperature are referred to as latent hardeners. When using latent hardeners, the epoxy resin and hardener may be mixed and stored for some time prior to use. Very latent hardeners enable one-component (1K) products to be produced, whereby the resin and hardener are supplied pre-mixed to the end user and only require heat to initiate curing.

The epoxy curing reaction may be accelerated by addition of small quantities of accelerators. Tertiary amines, carboxylic acids and alcohols (especially phenols) are effective accelerators. Bisphenol A was a highly effective and widely used accelerator. Nowadays, Bisphenol A has been replaced by DMP-30 or BDMA. In biological fields, epoxy resins for sample preparation are bought as kits comprising 4 compounds that vary depending on the supplier (for example Araldite, Spurr, Agar100, Embed812, Durcupan,). For example, commonly used components are glycid ether, Embed 812, DDSA and/or MNA. The fourth component is always the accelerator (DMP-30 or BDMA). The variation of the amounts of the 4 different components determine the viscosity of the liquid resin before curing critical for penetration in the stained biological sample. It is also determining the hardness of the cured resin and the properties of cutting of the resin. In this invention, the resin mixture used in this first step is determining the penetration of the resin in the tissue as well as the interaction with the silver epoxy added at the final step before curing. All these resins if used alone without silver embedding have a curing time of 24 h at 60° C. In combination with the silver epoxy, it has been found the final curing time is optimal when performed for 48 h at 60° C. The determination of the optimal curing temperature is routine for the skilled person.

Examples of epoxy resins having a curing schedule of 24 h at 60° C. are Araldite, Spurr, Agar100, Embed812, Durcupan, and Quetol.

As used herein, the singular forms “a”, “an,” and “the” include plural reference unless the context clearly dictates otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

### EXAMPLES

After the dehydration in acetone or ethanol, the sample has been incubated in a 1:1 vol. mixture of the last solvent and Epoxy resin. After 1 hour, the mixture has been replaced by 100% epoxy resin and the sample has been incubated for another hour. After this step, fresh resin has been added for an overnight incubation. All incubation steps have been performed at room temperature. After about 12 hours, the conductive medium has been prepared by mixing the conductive particles and epoxy resins and filled into a special curing mold. Then, the sample has been picked from the epoxy resin and any remaining excessive epoxy resin has been carefully removed from the surface of the sample. Finally the sample has been placed in the mold and carefully surrounded by the conductive medium. The conductive medium around the sample has been carefully homogenized and any air bubble around the sample has been removed. Once the silver epoxy fully covered the sample and was homogenous, the sample has been cured in an oven at 60° C. for 48 hours.

The comparative sample has been prepared according to the standard method, i.e. without the addition of conductive resin.

1. A method for preparing a sample for microscopy, said method comprising the steps of:
(a) contacting said sample with a first polymerizable resin under conditions and for a time sufficient for penetration of said first polymerizable resin into the sample,
(b) removing excessive first polymerizable resin from the surface of the sample,
(c) contacting the so-prepared sample containing said first polymerizable resin with a second polymerizable resin preparation, said second polymerizable resin preparation containing a high concentration of electrically conductive particles, and
(d) subjecting the so-prepared sample to the curing temperature of the polymerizable resins,
wherein the curing temperature of said second polymerizable resin preparation is substantially the same as the curing temperature of the first polymerizable resin.

2. The method of claim 1, wherein the polymerizable resin is a thermosetting polymer.

3. The method of claim 1 wherein at least one of the polymerizable resin is an epoxy resin.

4. The method of claim 1 wherein the first polymerizable resin is a water-soluble epoxy resin.

5. The method of claim 1 wherein the electrically conductive particles comprise gold particles, silver particles, nickel particle, graphite particles, and/or silver-coated particles.

6. The method of claim 1 wherein the electrically conductive particles are nanoparticles

7. The method of claim 1 wherein the concentration of electrically conductive particles is between 30 and 90 WT %.

8. A kit for preparing a sample for microscopy comprising:
(a) a container containing electrically conductive particles, and
(b) a container containing an epoxy resin,
wherein said epoxy resin has a curing schedule of about 24 h at about 60° C.

9. The kit of claim 8 wherein the electrically conductive particles comprise gold particles, silver particles, nickel particle, graphite particles, and/or silver-coated particles.

10. The kit of claim 8 wherein the electrically conductive particles are nanoparticles.
